(19) United States
(12) Patent Application Publication
(10) Pub. No.: US 2020/0263025 A1
(43) Pub. Date: Aug. 20, 2020

(54) A Core-Shell Nanoparticle

(71) Applicant: AGENCY FOR SCIENCE, TECHNOLOGY AND RESEARCH, Singapore (SG)

(72) Inventors: Zibiao Li, Singapore (SG); Beng Hoon Maureen Janet Tan, Singapore (SG); Xian Jun Loh, Singapore (SG); Jing Yang, Singapore (SG)

(21) Appl. No.: 16/647,053

(22) PCT Filed: Oct. 12, 2018
(86) PCT No.: PCT/SG2018/050516

§ 371 Date: Mar. 13, 2020

(30) Foreign Application Priority Data
Oct. 12, 2017 (SG) 10201708451S

(51) Int. Cl. C08L 51/10; B01J 20/10; C02F 1/28; B01J 20/06; B01J 20/34; B01J 20/32; B01J 20/28; C02F 1/40; C08F 220/18; C08K 3/36; C08K 9/04

(52) U.S. Cl. CPC C08L 51/10; B82Y 30/00; C02F 1/288; B01J 20/06; B01J 20/3433; B01J 20/3293; B01J 20/3282; B01J 20/3276; B01J 20/3204; B01J 20/28007; C02F 1/40; C08F 220/18; C08K 3/36; C08K 9/04; C08K 2201/011; B01J 20/103

(57) ABSTRACT

The present invention relates to a core-shell nanoparticle comprising (a) an inorganic core comprising a nanoparticle comprising a metal, a metal oxide or combination thereof, and a silica component; (b) a shell material comprising a copolymer having at least two polymers selected from a pH-responsive polymer and a hydrophobic polymer; and (c) a crosslinker that conjugates the shell material to the inorganic core. There is also provided a method for producing the core-shell nanoparticle and uses thereof.

### CROSS-REFERENCE TO RELATED APPLICATION

This application claims priority to Singapore application number 10201708451S filed on 12 Oct. 2017, the disclosure of which is hereby incorporated by reference.

### TECHNICAL FIELD

The present invention generally relates to a core-shell nanoparticle. The present invention also relates to a method of preparing the core-shell nanoparticle, the uses and methods of uses thereof.

### BACKGROUND ART

Oil-induced water pollution has attracted more and more attention in the recent years due to the discharge of industrial oily wastewater and frequently-occurring crude oil spill incidents. It has been a great challenge to find an environmentally-friendly and effective way to separate the oil from water, especially for highly stable emulsified oil/water mixtures. Usually in practical applications, many types of hydrophobic/oleophilic oil-absorbent materials are used for absorbing the oil from water. However, due to their poor absorption selection, the need to further remove water from the absorbed oil lowers the separation efficiency. The complete separation of oil/water would be achievable if the separation materials can selectively absorb one (oil or water) and completely repel the other (water or oil). The development of interface science provides an opportunity to solve the problem. To date, two different types of surfaces, superhydrophobic/superoleophilic and underwater superoleophobic surfaces, have been successfully developed by the combination of appropriate chemical composition and a hierarchical rough structure, and employed in oil/water separation on the basis of their selective oil/water wettability.

Magnetic micro- or nano-particles with superhydrophobic/superoleophilic surfaces have been developed as one of the promising materials for enrichment and removal of oil from oil/water emulsions. These magnetic powders are usually decorated by hydrophobic small molecules or macromolecules. Due to the fact that the hydrophobicity is easily magnified by the rough surfaces of the particles' aggregates, these magnetic materials generally show superwettability towards oil. The magnetic particles can be easily dispersed into the emulsions by shaking or sonication, and then separated with absorbed oil under magnetic field. However, these magnetic particles are commonly renewed and recycled by washing with a large amount of organic solvent. In addition, the oil absorption capacity of renewed particles might be reduced due to the inadequate washing. If the oil adhesion of absorbents could be switched to repellency under certain stimulus, these materials would easily achieve controlled capture and then release of oil. The change of pH as a stimulus could be easily realized in aqueous media, and pH-sensitive small molecules and macromolecules have been used to construct surfaces with switchable superwettability.

Recently, poly(dimethylaminoethylmethacrylate) (PDMAEMA) based core-shell hybrid magnetic nanoparticles with pH-tunable interfacial activity have been reported to separate oil in water emulsions via reversibly forming and breaking Pickering emulsion. However, the nanoparticles' magnetism induced aggregation and wettability of homopolymer towards oil both significantly limited the separation efficiency.

In comparison with microemulsions, separation of oil from water in oil-in-water nanoemulsions remains a significant challenge as the nanoemulsions are highly stable and may be present in the oil-water interface. The formation of nanoemulsions is widely encountered in a wide spectrum of chemical processes such as in pharmaceutical, food and cosmetic industry, which may pose severe threat to both the environment and human health. Owing to the ultrahigh stability, the breakdown of water/oil nanoemulsions is relatively more complex and may require more energy input and chemical additions than the treatment of microemulsions.

Accordingly, there is a need for a core-shell nanoparticle that has good oil/water separation properties, which addresses or alleviates one or more disadvantages mentioned above.

### SUMMARY

According to a first aspect, there is provided a core-shell nanoparticle comprising: a) an inorganic core comprising a nanoparticle comprising a metal, a metal oxide or combination thereof, and a silica component; b) a shell material comprising a copolymer having at least two polymers selected from a pH-responsive polymer and a hydrophobic polymer; and c) a crosslinker that conjugates the shell material to the inorganic core.

Advantageously, the silica component may prevent aggregation of the metal or metal oxide present in the core of the core-shell nanoparticle. The silica component may prevent the metal or metal oxide core from corrosion when exposed to an acidic environment.

More advantageously, the copolymer of the shell material may be designed and modelled through density functional theory (DFT) simulation. The copolymer may have switchable oil wettability when placed in an environment where the pH level is varied.

Advantageously, the core-shell nanoparticle may be used to absorb oil. The core-shell nanoparticle may have an oil absorption capacity of at least 50 times of its own per unit weight, at least 60 times, at least 70 times or preferably at least 78 times of its own weight. The core-shell nanoparticle may have an oil absorption ratio of about 7700 to about 7900%, about 7700 to about 7850%, about 7700 to about 7800%, about 7700 to about 7750%, about 7750 to about 7900%, about 7800 to about 7900% or about 7850 to about 7900%. The core-shell nanoparticle may have an oil absorption ratio of about 7820%. The high absorption capacity of the core-shell nanoparticle may be due to the higher density of the triblock copolymer on the surface of inorganic core.

More advantageously, the core-shell nanoparticle may have a good stability and reusability. The core-shell nanoparticle may be recyclable. The core-shell nanoparticle may be recycled at least 3 times.

According to another aspect, there is provided a method of preparing a core-shell nanoparticle comprising the step of conjugating an inorganic core comprising a metal, a metal oxide or combination thereof and a silica component, with a shell material comprising a copolymer having at least two polymers selected from a pH-responsive polymer and a hydrophobic polymer.

According to another aspect, there is provided use of a core-shell nanoparticle to remove oil and surfactant in an oil-in-water nanoemulsion, wherein said core-shell nanoparticle comprises (a) an inorganic core comprising a nanoparticle comprising a metal, a metal oxide or combination thereof, and a silica component; (b) a shell material comprising a copolymer having at least two polymers selected from a pH-responsive polymer and a hydrophobic polymer; and (c) a crosslinker that conjugates the shell material to the inorganic core. The core-shell nanoparticle may be used to remove oil and surfactant in an oil-in-water nanoemulsion and may not require the use of additional chemical additives to do so.

According to another aspect, there is provided a method of removing oil and surfactant in an oil-in-water nanoemulsion comprising the steps of (a) mixing a core-shell nanoparticle in the oil-in-water nanoemulsion; (b) adjusting the pH of the nanoemulsion to thereby trap the oil in the nanoemulsion on the surface of the core-shell nanoparticle; and (c) applying an external magnetic field to separate the core-shell nanoparticle with entrapped oil from the water in the nanoemulsion, wherein said core-shell nanoparticles comprises (i) an inorganic core comprising a nanoparticle comprising a metal, a metal oxide or combination thereof, and a silica component; (ii) a shell material comprising a copolymer having at least two polymers selected from a pH-responsive polymer and a hydrophobic polymer; and (iii) a crosslinker that conjugates the shell material to the inorganic core.

According to another aspect, there is provided a method of separating oil from an oil-absorbed core-shell nanoparticle comprising the steps of (a) immersing the oil-absorbed core-shell nanoparticle into a solution of acid; and (b) washing the oil off the surface of the oil-absorbed core-shell nanoparticle with an aqueous solution at neutral pH, wherein said core-shell nanoparticles comprises (i) an inorganic core comprising a nanoparticle comprising a metal, a metal oxide or combination thereof, and a silica component; (ii) a shell material comprising a copolymer having at least two polymers selected from a pH-responsive polymer and a hydrophobic polymer; and (iii) a crosslinker that conjugates the shell material to the inorganic core.

Advantageously, the core-shell nanoparticle may be recyclable after the method of separating oil from an oil-absorbed core-shell nanoparticle. The core-shell nanoparticle may be recycled at least three times.

### Definitions

The following words and terms used herein shall have the meaning indicated:

The term “oleophilic” as used herein refers to of or relating to a substance that has an affinity for oils and not for water, such as one that has a stronger affinity for oils.

The term “pH-responsive polymer” as used herein refers to a polymer that responds to changes in the pH of the surrounding medium by varying their dimensions. The polymer may swell, collapse, or change depending on the pH of its environment. The term “pH sensitive” may also be used interchangeably with the term “pH-responsive polymer”.

The term “polymer” as used herein refers to a large molecule, or macromolecule, composed of a number of repeating units, up to 30 in total of the same repeating units, whereby the repeating unit may be any functional groups that as required, have pH-responsive properties or hydrophobic properties.

“Alkyl” as a group or part of a group refers to a straight or branched aliphatic hydrocarbon group to be interpreted broadly, having from 1 to 16 carbon atoms, e.g., 1, 2, 3, 4, 5, 6, 7, 8, 9, 10, 11, 12, 13, 14, 15 or 16 carbon atoms, preferably a C₁-C₁₆ alkyl, C₁-C₁₂ alkyl, more preferably a C₁-C₁₀ alkyl, most preferably C₁-C₆ alkyl unless otherwise noted. Examples of suitable straight and branched alkyl substituents include but is not limited to, methyl, ethyl, 1-propyl, isopropyl, 1-butyl, 2-butyl, isobutyl, tert-butyl, amyl, 1,2-dimethylpropyl, 1,1-dimethylpropyl, pentyl, isopentyl, hexyl, 4-methylpentyl, 1-methylpentyl, 2-methylpentyl, 3-methylpentyl, 2,2-dimethylbutyl, 3,3-dimethylbutyl, 1,2-dimethylbutyl, 1,3-dimethylbutyl, 5-methylheptyl, 1-methylheptyl, octyl, nonyl, decyl, undecyl, 2,2,3-trimethyl-undecyl, dodecyl, 2,2-dimethyl-dodecyl, tridecyl, 2-methyl-tridecyl, 2-methyl-tridecyl, tetradecyl, 2-methyl-tetradecyl, pentadecyl, 2-methyl-pentadecyl, hexadecyl, 2-methyl-hexadecyl and the like. The alkyl may be optionally substituted with one or more groups as defined under the term “optionally substituted” below.

“Aryl” as a group or part of a group to be interpreted broadly denotes (i) an optionally substituted monocyclic, or fused polycyclic, aromatic carbocycle (ring structure having ring atoms that are all carbon) preferably having from 5 to 12 atoms per ring, e.g. 5, 6, 7, 8, 9, 10, 11 or 12 carbon atoms, wherein the optionally substitution can be di-substitution, or tri-substitution.

Examples of aryl groups include phenyl, naphthyl, and the like; (ii) an optionally substituted partially saturated bicyclic aromatic carbocyclic moiety in which a phenyl and a C₅₋₇ cycloalkyl or C₅₋₇cycloalkenyl group are fused together to form a cyclic structure, such as tetrahydronaphthyl, indenyl or indanyl. The group may be a terminal group or a bridging group. Typically an aryl group is a C₆-C₁₈ aryl group. The aryl may be optionally substituted with one or more groups as defined under the term “optionally substituted” below. Preferably the groups may include ortho-phenylene group, para-phenylene group and meta-phenylene group where it is used interchangeably with o-phenylene group, p-phenylene group and m-phenylene group.

“Alkylaryl” refers to an alkyl-aryl group in which alkyl and aryl moieties are as defined herein. Alternatively, “arylalkyl” refers to an aryl-alkyl group in this sequence, in which aryl and alkyl moieties are as defined herein. Preferred alkylaryl groups are C₁-C₄-alkylaryl having 6 or 10 carbon atoms in the aryl. Preferred arylalkyl groups are aryl-C₁-C₄-alkyl having 6 or 10 carbon atoms in the aryl. The group may be a terminal group or a bridging group. If the group is a terminal group it is bonded to the remainder of the molecule through the aryl group. The alkyl moiety of the alkylaryl or arylalkyl may also be the terminating molecule.

“Alkyloxy” or “alkoxy” may be used interchangeably, refers to an alkyl-O-group in which alkyl moiety is as defined herein, preferably a C₁-C₁₆alkyloxy, C₁-C₁₂alkyloxy, C₁-C₁₀alkyloxy or more preferably, the alkyloxy is a C₁-C₆alkyloxy. Examples include, but are not limited to, methoxy and ethoxy. The group may be a terminal group or a bridging group.

A “bond” is a linkage between atoms in a compound or molecule. The bond may be a single bond, a double bond, or a triple bond.

“Bridging group” refers to a group having from 2 to 50 atoms not counting hydrogen atoms, preferably 2 to 40 atoms, 2 to 30 atoms, 2 to 20 atoms, e.g. more preferably 2 to 20 carbon atoms, more preferably 2 to 16 carbon atoms, e.g. 2, 3, 4, 5, 6, 7, 8, 9, 10, 11, 12, 13, 14, 15 or 16 carbon atoms, a C₁-C₁₆ alkyl, C₁-C₁₂ alkyl, more preferably a C₁-C₆ alkyl, most preferably C₁-C₆ alkyl in the normal chain. The alkyl group may be divalent alkyl, alkenyl, alkynyl, aryl group but not limited to this. Exemplary alkyl groups include, but are not limited to, ethenylene (—CH₂CH₂—) group, ortho-phenylene group, para-phenylene group or meta-phenylene group. The bridging group may be optionally substituted with one or more groups as defined under the term “optionally substituted” below.

“Cycloalkyl” refers to a cyclic-alkyl group in which alkyl moiety is as defined herein. “Cyclo” or “cyclic” refers to a non-straight hydrocarbon group to be interpreted broadly, having from 1 to 16 carbon atoms, e.g., 1, 2, 3, 4, 5, 6, 7, 8, 9, 10, 11, 12, 13, 14, 15 or 16 carbon atoms, preferably a C₁-C₁₆ alkyl, C₁-C₁₂ alkyl, more preferably a C₁-C₁₀ alkyl, most preferably C₁-C₆ alkyl unless otherwise noted. The cycloalkyl group may be optionally substituted.

“Halide” or “halogen” represents chlorine, fluorine, bromine or iodine.

“Haloalkyl” refers to a halo-alkyl group in which halo and alkyl moieties are as defined herein. Preferred halo-alkyl groups are halo-C₁-C₆-alkyl group or halo-C₁-C₃-alkyl group. Examples include, but are not limited to, iodopropyl. The group may be a terminal group or a bridging group.

“Heteroaryl” either alone or part of a group refers to groups containing an aromatic ring (preferably a 5 or 6 membered aromatic ring) having one or more heteroatoms as ring atoms in the aromatic ring with the remainder of the ring atoms being carbon atoms. The aromatic rings may be monocyclic, fused or bridged or spiro polycyclic ring fused with another aromatic ring (preferably a 5 or 6 membered aromatic ring). Suitable heteroatoms include nitrogen, oxygen and sulphur. Examples of heteroaryl include pyridyl, tetrazolyl, triazolyl, pyrimidinyl, pyrazinyl, thiophenyl, furanyl, indazolyl, benzoxazolyl, benzofuranyl, benzothiophenyl, indolyl, pyrrolyl, oxazolyl, pyrazolyl, thiazolyl, quinolinyl, imidazolyl, purinyl, oxadiazolonyl. A heteroaryl group is typically a C1-C18 heteroaryl group. A heteroaryl group may comprise 3 to 8 ring atoms. A heteroaryl group may comprise 1 to 3 heteroatoms independently selected from the group consisting of N, O and S. The group may be a terminal group or a bridging group.

“Silica” as used herein also refers to silicon dioxide (SiO₂).

“Silane” as used herein, refers to an inorganic compound with chemical formula, SiH₄.

The chemical term silane may be used as a group or part of a group, where the hydride (H) is replaced with other functional groups as defined herein, to be interpreted broadly. Preferably, as alkyl silane, or more preferably alkoxy silane unless otherwise noted. The group may be a terminal group or a bridging group.

The term “wettability” as used herein, refers to the tendency of one fluid (oil or water) to spread on, or adhere to, a solid surface in the presence of other immiscible fluids. The term “wettability” also refers to the (intermolecular) interactions between fluid and solid phases, i.e. the ability of a liquid to maintain contact with a solid surface. The degree of wetting (wettability) is determined by a force balance between adhesive and cohesive forces.

The term “optionally substituted” as used herein means the group to which this term refers may be unsubstituted, or may be substituted with one or more groups independently selected from alkyl, alkenyl, alkynyl, thioalkyl, cycloalkyl, cycloalkylalkyl, cycloalkenyl, cycloalkylalkenyl, heterocycloalkyl, cycloalkylheteroalkyl, cycloalkyloxy, cycloalkenyloxy, cycloamino, halo, carboxyl, haloalkyl, haloalkynyl, alkynyloxy, heteroalkyl, heteroalkyloxy, hydroxyl, hydroxyalkyl, alkoxy, thioalkoxy, alkenyloxy, haloalkoxy, haloalkenyl, haloalkynyl, haloalkenyloxy, nitro, amino, nitroalkyl, nitroalkenyl, nitroalkynyl, nitroheterocyclyl, alkylamino, dialkylamino, alkenylamine, aminoalkyl, alkynylamino, acyl, alkyloxy, alkyloxyalkyl, alkyloxyaryl, alkyloxycarbonyl, alkyloxycycloalkyl, alkyloxyheteroaryl, alkyloxyheterocycloalkyl, alkenoyl, alkynoyl, acylamino, diacylamino, acyloxy, alkylsulfonyloxy, heterocyclic, heterocycloalkenyl, heterocycloalkyl, heterocycloalkylalkyl, heterocycloalkylalkenyl, heterocycloalkylheteroalkyl, heterocycloalkyloxy, heterocycloalkenyloxy, heterocycloxy, heterocycloamino, haloheterocycloalkyl, alkylsulfinyl, alkylsulfonyl, alkylsulfenyl, alkylcarbonyloxy, alkylthio, acylthio, aminosulfonyl, phosphorus-containing groups such as phosphono and phosphinyl, sulfinyl, sulfinylamino, sulfonyl, sulfonylamino, aryl, heteroaryl, heteroarylalkyl, heteroarylalkenyl, heteroarylheteroalkyl, heteroarylamino, heteroaryloxy, arylalkenyl, alkenylaryl, arylalkyl, alkylaryl, alkylheteroaryl, aryloxy, arylsulfonyl, cyano, cyanate, isocyanate, —C(O)NH(alkyl), and —C(O)N(alkyl)₂. Where the term “substituted” is used, the group to which this term refers to may be substituted with one or more of the same groups mentioned above.

The word “substantially” does not exclude “completely” e.g. a composition which is “substantially free” from Y may be completely free from Y. Where necessary, the word “substantially” may be omitted from the definition of the invention.

Unless specified otherwise, the terms “comprising” and “comprise”, and grammatical variants thereof, are intended to represent “open” or “inclusive” language such that they include recited elements but also permit inclusion of additional, unrecited elements.

As used herein, the term “about”, in the context of concentrations of components of the formulations, typically means+/−5% of the stated value, more typically +/−4% of the stated value, more typically +/−3% of the stated value, more typically, +/−2% of the stated value, even more typically +/−1% of the stated value, and even more typically +/−0.5% of the stated value.

Throughout this disclosure, certain embodiments may be disclosed in a range format. It should be understood that the description in range format is merely for convenience and brevity and should not be construed as an inflexible limitation on the scope of the disclosed ranges. Accordingly, the description of a range should be considered to have specifically disclosed all the possible sub-ranges as well as individual numerical values within that range. For example, description of a range such as from 1 to 6 should be considered to have specifically disclosed sub-ranges such as from 1 to 3, from 1 to 4, from 1 to 5, from 2 to 4, from 2 to 6, from 3 to 6 etc., as well as individual numbers within that range, for example, 1, 2, 3, 4, 5, and 6. This applies regardless of the breadth of the range.

Certain embodiments may also be described broadly and generically herein. Each of the narrower species and subgeneric groupings falling within the generic disclosure also form part of the disclosure. This includes the generic description of the embodiments with a proviso or negative limitation removing any subject matter from the genus, regardless of whether or not the excised material is specifically recited herein.

### Detailed Disclosure of Optional Embodiments

Exemplary, non-limiting embodiments of a core-shell nanoparticle will now be disclosed.

The core-shell nanoparticle comprises (a) an inorganic core comprising a nanoparticle comprising a metal, a metal oxide or combination thereof, and a silica component; (b) a shell material comprising a copolymer having at least two polymers selected from a pH-responsive polymer and a hydrophobic polymer; and (c) a crosslinker that conjugates the shell material to the inorganic core.

The metal of the metal nanoparticle or of the metal oxide nanoparticle may be selected from a magnetic material, a ferromagnetic, a ferromagnetic material or a superparamagnetic material. The metal of the metal nanoparticle or of the metal oxide nanoparticle may be a ferromagnetic material. The metal of the metal nanoparticle or of the metal oxide nanoparticle may be selected from the group consisting of iron, cobalt, nickel, chromium, alloys of cerium, dysprosium, erbium, europium, gadolinium, holmium, lanthanum, lutetium, neodymium, praseodymium, promethium, samarium, scandium, terbium, thulium, ytterbium and yttrium and mixtures thereof.

Where the nanoparticle is a metal oxide nanoparticle, the metal oxide of the metal oxide nanoparticle may be selected from the group consisting of iron (III) oxide, iron (II) oxide, cobalt (III) oxide, cobalt (II) oxide, nickel (III) oxide, nickel (II) oxide, copper (II) oxide or copper (I) oxide, chromium (III) oxide, chromium (II) oxide, or a mixture of these oxides.

Where the nanoparticle is a combination of the metal and metal oxide, this may be a combination of Fe, Fe₂O₃, FeO, Fe₃O₄, Co, CoO, Co₂O₃, Ni, NiO, Cu, CuO, Cr and Cr₃O₄.

The metal of the metal nanoparticle, metal oxide nanoparticle or combination thereof may be iron. The metal oxide of the metal nanoparticle may be iron (II) oxide or iron (III) oxide. The metal oxide of the metal oxide nanoparticle may be Fe₃O₄. The metal nanoparticle may be iron nanoparticle. The metal oxide nanoparticle may be Fe₃O₄ nanoparticle.

The metal or metal oxide nanoparticle may be of spherical or non-spherical shape. The diameter or equivalent diameter (when referring to non-spherical nanoparticles) of the metal or metal oxide nanoparticle may be in the range of about 1 to about 50 nm, about 1 to about 40 nm, about 1 to about 30 nm, about 1 to about 20 nm, about 1 to about 10 nm, about 10 to about 50 nm, about 20 to about 50 nm, about 30 to about 50 nm or about 40 to about 50 nm. The diameter (or equivalent diameter) of the metal or metal oxide nanoparticle may be about 10 nm. The surface of the metal or metal oxide nanoparticle may be functionalized with a crosslinker.

The metal or metal oxide nanoparticle may be magnetic, ferromagnetic or superparamagnetic. The metal or metal oxide nanoparticle may be attracted to an external magnetic field. The external magnetic field may be a magnet.

The silica component may be made up of a hydrocarbon group, an alkyl aryl group, an alkoxy silane group or combinations thereof. The silica component may be made up of alkoxy silane groups. The silica component may be made up of tetraethyl orthosilicate. The silica component may be a layer or a coating of SiO₂.

Advantageously, the silica component may prevent aggregation of the metal or metal oxide in the core of the core-shell nanoparticle. The silica component may prevent the metal or metal oxide core from corrosion when placed in an acidic environment.

The copolymer making up the shell material may be a block copolymer or a grafted copolymer. Where the copolymer is a block copolymer, the block copolymer may have at least two blocks, where one block is the pH-responsive polymer and the other block is the hydrophobic polymer. The block copolymer may be a triblock copolymer (that is, having three blocks of the two polymers, one being the pH-responsive polymer and the other being the hydrophobic polymer) whereby one of the at least two polymers is repeated as a third block. The triblock copolymer may have a sequence of a pH-responsive block-a hydrophobic block-a pH-responsive block. The triblock copolymer may be of other types of block or graft architecture. The triblock copolymer may be grafted on or conjugated onto the inorganic core comprising a nanoparticle mentioned above and a silica component via the crosslinker.

The triblock copolymer as defined above may have higher oil capture capability compared to the monoblock or diblock counterpart. Further, the triblock copolymer may be used in a wider range of process condition at any pH above 7 that may be due to the intrinsic nature of such triblock copolymer. In addition, when the triblock copolymer as defined above is used, a higher efficiency for the separation of oil/water may be achieved. The two pH-responsive blocks in the triblock copolymer having a sequence of a pH-responsive block-a hydrophobic block-a pH-responsive block as defined above, may be of the same or different polymer. Non-limiting examples of such triblock copolymer having a sequence of a pH-responsive block-a hydrophobic block-a pH-responsive block (with identical pH-responsive block) include P4VP-PDMS-P4VP, P4VP-polytetrafluoroethylene(PTFE)-P4VP, poly(2-vinylpyridine)(P2VP)-PDMS-P2VP, P2VP-PTFE-P2VP, poly(methacrylic acid)(PMAA)-poly(methyl methacrylate) (PMMA)-PMAA, polyacrylic acid(PAA)-PMMA-PAA and PMAA-poly(2-dimethylamino ethylmethacrylate)(PDMAEMA)-PMAA. Non-limiting examples of such triblock copolymer having a sequence of a pH-responsive block-a hydrophobic block-a pH-responsive block (with two different pH-responsive blocks) include P4VP-PDMS-P2VP, P4VP-PTFE-P2VP, PMAA-PMMA-PAA and PMAA-PDMAEMA-PAA.

The pH-responsive polymer of the copolymer may be substituted with different types of pH-sensitive polymers. The pH-responsive block may be selected from the group consisting of poly(4-vinylpyridine) (P4VP), poly(2-vinylpyridine) (P2VP), poly(methacrylic acid) (PMAA), poly(acrylic acid) (PAA) and poly(dimethylaminoethyl methacrylate) (PDMAEMA). The pH-responsive polymer may be poly(4-vinylpyridine) (P4VP). The pH-responsive polymer may be sensitive to pH levels of 1, 2, 3, 4, 5, 6, 7, 8, 9, 10, 11, 12, 13 and 14. The pH-responsive polymer may respond to different pH levels of 1, 2, 3, 4, 5, 6, 7, 8, 9, 10, 11, 12, 13 and 14.

The hydrophobic polymer of the copolymer may have oleophilic properties. The hydrophobic polymer may be oleophilic. The hydrophobic polymer may be substituted with different types of hydrophobic/oleophilic polymers or copolymers that can have strong interaction with oil in oil-in-water nanoemulsions. The hydrophobic/oleophilic polymer may be selected from the group consisting of poly(dimethylsiloxane) (PDMS), poly(methyl methacrylate) (PMMA), polytetrafluoroethylene (PTFE), thermoplastic polyurethane (TPU) and polyvinylidene fluoride (PVDF). The hydrophobic polymer may be poly(dimethylsiloxane) (PDMS).

Advantageously, the copolymer may be designed and modelled through density functional theory (DFT) simulation. The copolymer may comprise switchable oil wettability when the pH level is varied, that is, the copolymer may be able to absorb and release the absorbed oil when the copolymer is subjected to an environment that has a pH that favours the absorption of the oil and then a pH that favours the release of the absorbed oil from the copolymer.

The crosslinker may be a bifunctional crosslinker. The bifunctional crosslinker may be provided on the surface of the inorganic core. The crosslinker may act as an intermediate anchoring layer for the copolymer. The crosslinker may conjugate or graft the copolymer to the inorganic core. The crosslinker may comprise alkyl groups, alkoxy groups, halogen groups, haloalkyl groups or silane groups or combinations thereof on the same compound. In order to conjugate the copolymer to the core, the crosslinker may have end or terminal groups that are suitable for conjugating or interacting with the copolymer and the core, such end or terminal groups being the haloalkyl group and the silane group.

The crosslinker may be (3-iodopropyl) trimethoxysilane (IPTMS).

The core and the shell material may be in a weight ratio of approximately 10:90 to 90:10, 10:90 to 80:20, 10:90 to 70:30, 10:90 to 60:40, 10:90 to 50:50, 10:90 to 40:60, 10:90 to 30:70, 10:90 to 20:80, 20:80 to 90:10, 30:70 to 90:10, 40:60 to 90:10, 50:50 to 90:10, 60:40 to 90:10, 70:30 to 90:10, 80:20 to 90:10, or preferably in a weight ratio of 62:38.

Advantageously, the core-shell nanoparticle may have an oil absorption capacity of at least 50 times of its own per unit weight, at least 60 times, at least 70 times or preferably at least 78 times of its own weight. The core-shell nanoparticle may have an oil absorption ratio of about 7700 to about 7900%, about 7700 to about 7850%, about 7700 to about 7800%, about 7700 to about 7750%, about 7750 to about 7900%, about 7800 to about 7900% or about 7850 to about 7900%. The core-shell nanoparticle may have an oil absorption ratio of about 7820%. The high absorption capacity of the core-shell nanoparticle may be due to the higher density of the triblock copolymer on the surface of inorganic core.

Advantageously, the core-shell nanoparticle may have a good stability and reusability. The core-shell nanoparticle may be recyclable. The core-shell nanoparticle may be recycled at least 3 times.

Exemplary, non-limiting embodiments of a method of preparing a core-shell nanoparticle will now be disclosed.

The method of preparing a core-shell nanoparticle may comprise the step of conjugating an inorganic core comprising a metal, a metal oxide or combination thereof and a silica component, with a shell material comprising a copolymer having at least two polymers selected from a pH-responsive polymer and a hydrophobic polymer

The method may comprise the steps of:

a) providing a nanoparticle comprising a metal, a metal oxide or combination thereof coated with a silica layer;

b) providing a copolymer having at least two polymers selected from a pH-responsive polymer and a hydrophobic polymer; and

c) conjugating said nanoparticle with said copolymer to form the core-shell nanoparticle whereby said nanoparticle forms the core and said copolymer forms the shell.

The method may comprise the steps of:

a) coating the surface of a nanoparticle comprising a metal, a metal oxide or combination thereof with a silica layer to form an inorganic core;

b) immersing the inorganic core in a solution of crosslinker;

c) immersing the inorganic core with the crosslinker in a solution of copolymer to obtain the core-shell nanoparticle.

The nanoparticle may be a metal oxide nanoparticle. The metal of the metal nanoparticle or the metal oxide nanoparticle may be iron. The metal oxide of the nanoparticle may be iron (II) oxide or iron (Ill) oxide. The metal oxide of the nanoparticle may be Fe₃O₄. The metal nanoparticle may be iron nanoparticle or the metal oxide nanoparticle may be Fe₃O₄ nanoparticle. The metal or metal oxide nanoparticle may be prepared by adding a metal reactant or metal oxide precursor with a fatty acid and thereafter heated at a first temperature under stirring for a period of time. After that, the reaction mixture may be further heated to a second temperature under stirring at a specific rate for a period of time. The mixture may then be cooled down to an appropriate temperature, and the metal or metal oxide nanoparticle may be collected by any suitable technique, such as by centrifuging and washing by a standard non-polar solvent/polar solvent approach for a number of times.

The first temperature used to heat the reaction may be about 120 to about 200° C., about 120 to about 130° C., about 120 to about 140° C., about 120 to about 150° C., about 120 to about 160° C., about 120 to about 170° C., about 120 to about 180° C., about 120 to about 190° C., about 130 to about 200° C., about 140 to about 200° C., about 150 to about 200° C., about 160 to about 200° C., about 170 to about 200° C., about 180 to about 200° C. or about 190 to about 200° C. The reaction may be heated at a temperature of about 160° C. The reaction may be stirred for a period of time in the range about 10 to about 60 minutes, about 10 to about 50 minutes, about 10 to about 40 minutes, about 10 to about 30 minutes, about 10 to about 20 minutes, about 20 to about 60 minutes, about 30 to about 60 minutes, about 40 to about 60 minutes or about 50 to about 60 minutes. The stirring may be for about 30 minutes. The solvent used for the reaction may be a non-polar solvent. The solvent may be octadecene. The reaction may be stirred under an inert gas flow. The inert gas flow may be argon or nitrogen. The inert gas flow may be argon.

The second temperature used in the reaction may be in the range of about 280 to about 340° C., about 280 to about 330° C., about 280 to about 320° C., about 280 to about 310° C., about 280 to about 300° C., about 280 to about 290° C., about 290 to about 340° C., about 300 to about 340° C., about 310 to about 340° C., about 320 to about 340° C. or about 330 to about 340° C. The second temperature may be at about 320° C. The reaction may be stirred for a period of time in the range about 30 to about 90 minutes, about 30 to about 80 minutes, about 30 to about 70 minutes, about 30 to about 60 minutes, about 30 to about 50 minutes, about 30 to about 40 minutes, about 40 to about 90 minutes, about 50 to about 90 minutes, about 60 to about 90 minutes, about 70 to about 90 minutes or about 80 to about 90 minutes. The second stirring may be for 60 minutes. The standard non-polar solvent/polar solvent may be a hexane/isopropanol solvent. The metal nanoparticle may be prepared via a solvothermal method.

The silica layer may be the silica component. The silica layer may be prepared on the inorganic core by dispersing the metal or metal oxide nanoparticle into a flask containing alkyl aryl groups in a non-polar solvent and left to stir at a temperature for a period of time. A basic solution may be added to form a reverse microemulsion solution that may be coloured. After further stirring for a period of time, a solution of alkoxy silane may be added and the reaction may be aged for a period of time. The coated final product may be collected such as by centrifugation and may be washed by an aqueous solution/polar protic solvent mixture for a number of times.

The alkyl aryl groups may be in the form of IGEPAL CO-520 reagent. The non-polar solvent may be a cycloalkyl solvent. The non-polar solvent may be cyclohexane. The reaction may be stirred at a temperature of about 20 to about 40° C., about 20 to about 35° C., about 20 to about 30° C., about 20 to about 25° C., about 25 to about 40° C., about 30 to about 40° C. or about 35 to about 40° C. The reaction may be stirred at room temperature. The stirring may be in the range about 30 to about 90 minutes, about 30 to about 80 minutes, about 30 to about 70 minutes, about 30 to about 60 minutes, about 30 to about 50 minutes, about 30 to about 40 minutes, about 40 to about 90 minutes, about 50 to about 90 minutes, about 60 to about 90 minutes, about 70 to about 90 minutes or about 80 to about 90 minutes. The stirring may be for about 60 minutes. The basic solution may be ammonia solution. The coloured reverse microemulsion solution may be a brownish reverse microemulsion solution.

The second stirring may be in the range about 30 to about 90 minutes, about 30 to about 80 minutes, about 30 to about 70 minutes, about 30 to about 60 minutes, about 30 to about 50 minutes, about 30 to about 40 minutes, about 40 to about 90 minutes, about 50 to about 90 minutes, about 60 to about 90 minutes, about 70 to about 90 minutes or about 80 to about 90 minutes. The second stirring may be for about 60 minutes.

The alkoxy silane may be tetraethyl orthosilicate. The reaction may be aged for about 10 to about 16 hours, about 10 to about 15 hours, about 10 to about 14 hours, about 10 to about 13 hours, about 10 to about 12 hours, about 10 to about 11 hours, about 11 to about 16 hours, about 12 to about 16 hours, about 13 to about 16 hours, about 14 to about 16 hours or about 15 to about 16 hours. The reaction may be aged overnight or about 12 hours. The aqueous solution/polar protic solvent mixture may be water/ethanol silicate mixture. The obtained product is then the metal or metal oxide nanoparticle (such as Fe₃O₄) with the silica layer.

The surface of the inorganic core may be functionalized with the crosslinker via silanization. The crosslinker may be a silane compound. The silane compound may be (3-iodopropyl) trimethoxysilane (IPTMS). The crosslinker may be provided on the surface of the inorganic core by dispersing the inorganic core in a non-polar solvent, mixed with the crosslinker and stirred for a period of time at a temperature. The silanized inorganic core may be washed with a non-polar solvent and a polar solvent twice to remove the unreacted silanes, followed by drying with a flow of inert gas. The surface functionalized inorganic core may be dispersed in a polar aprotic solvent for further preparation.

The crosslinking reaction may be stirred for about 10 to about 16 hours, about 10 to about 15 hours, about 10 to about 14 hours, about 10 to about 13 hours, about 10 to about 12 hours, about 10 to about 11 hours, about 11 to about 16 hours, about 12 to about 16 hours, about 13 to about 16 hours, about 14 to about 16 hours or about 15 to about 16 hours. The reaction may be stirred at a temperature of about 20 to about 40° C., about 20 to about 35° C., about 20 to about 30° C., about 20 to about 25° C., about 25 to about 40° C., about 30 to about 40° C. or about 35 to about 40° C. The reaction may be stirred at room temperature. The reaction may be stirred for about 12 hours. The non-polar solvent may be anhydrous or non-anhydrous. The non-polar solvent may be toluene. The polar aprotic solvent may be tetrahydrofuran (THF). The polar solvent may be ethanol. The inert gas may be nitrogen or argon. The inert gas may be nitrogen.

The copolymer may have the sequence of a pH-responsive block-a hydrophobic block-a pH-responsive block. The copolymer may be prepared by atomic transfer radical polymerization (ATRP). The hydrophobic block may be modified into ATRP macroinitiator hydrophobic-modified by esterification of the amino end group with a brominated reagent in a non-polar solvent. The brominated reagent may be added in excess with respect to the —NH₂ end groups and an amine reagent may be used to trap an acid by-product. The reactants may be stirred at a temperature for a period of time and the resultant solution may be washed with a basic aqueous solution for a number of times. The organic layer may be isolated and dried with a drying agent over a period of time and filtered, followed by vacuum drying at a temperature for a period of time. The product may be a hydrophobic-modified product.

The hydrophobic block may be a polysiloxane. The polysiloxane may be a poly(alkylsiloxane). The poly(alkylsiloxane) may be poly(dimethylsiloxane) (PDMS). The brominated reagent may be 2-bromoisobutyryl bromide. The brominated reagent may be added in excess up to six times, five times, four times, three times or two times. The brominated reagent may be added in excess up to five times with respect to the amino end groups. The amine reagent may be an alkylamine. The alkylamine may be triethylamine. The acid by-product may be hydrobromic acid generated during the reaction.

The reaction may be stirred at a temperature of about 20 to about 40° C., about 20 to about 35° C., about 20 to about 30° C., about 20 to about 25° C., about 25 to about 40° C., about 30 to about 40° C. or about 35 to about 40° C. The reaction may be stirred at room temperature. The stirring may be for a period of time in the range of about 20 to about 28 hours, about 20 to about 27 hours, about 20 to about 26 hours, about 20 to about 25 hours, about 20 to about 24 hours, about 20 to about 23 hours, about 20 to about 22 hours, about 20 to about 21 hours, about 21 to about 28 hours, about 22 to about 28 hours, about 23 to about 28 hours, about 24 to about 28 hours, about 25 to about 28 hours, about 26 to about 28 hours or about 27 to about 28 hours. The stirring may be for about 24 hours.

The non-polar solvent may be anhydrous or non-anhydrous. The non-polar solvent may be dichloromethane. The basic aqueous solution may be of aqueous sodium bicarbonate.

The drying agent may be any suitable drying agent. An exemplary drying agent may be magnesium sulphate. The time period used during drying may be in the range of about 2 to about 6 hours, about 2 to about 5 hours, about 2 to about 4 hours, about 2 to about 3 hours, about 3 to about 6 hours, about 4 to about 6 hours or about 5 to about 6 hours. The time period for drying may be of about 4 hours. The vacuum drying temperature may be in the range of about 20 to about 60° C., about 20 to about 50° C., about 20 to about 40° C., about 20 to about 30° C., about 30 to about 60° C., about 40 to about 60° C. or about 50 to about 60° C. The vacuum drying temperature may be about 40° C. The vacuum drying period may be in the range of about 10 to about 16 hours, about 10 to about 15 hours, about 10 to about 14 hours, about 10 to about 13 hours, about 10 to about 12 hours, about 10 to about 11 hours, about 11 to about 16 hours, about 12 to about 16 hours, about 13 to about 16 hours, about 14 to about 16 hours or about 15 to about 16 hours. The vacuum drying period may be overnight or about 12 hours. The hydrophobic-modified product may be PDMS-diBr product.

The hydrophobic-modified product may be used as a macroinitiator and react with a catalyst and the pH-responsive block in a closed environment. The closed environment may contain inert gas. An additive and a polar protic solvent/polar aprotic solvent solution may be added into the closed environment having the inert gas atmosphere. Polymerization may proceed under continuous stirring at a temperature for a period of time. The reaction may be stopped by diluting the reaction mixture with a polar aprotic solvent and exposing it to ambient atmosphere for a period of time. The additive complex may be removed by passing the reaction mixture through a short column. After concentrating the filtrates, the solutions may be dialyzed against aqueous solution for a period of time followed by freeze drying. The triblock copolymer may be P4VP-PDMS-P4VP.

The catalyst may be a suitable catalyst that can be used as a polymerization catalyst. The polymerization catalyst may be N,N,N′,N″,N″-pentamethyldiethylenetriamine (PMDETA). The pH-responsive block may be 4-vinylpyridine where the catalyst/macroinitiator may initiate the polymerization of 4-vinylpyridine to poly(4-vinylpyridine) (P4VP). The inert gas may be nitrogen or argon. The inert gas may be nitrogen. The additive may be copper bromide (CuBr). The additive complex may be a copper complex. The polar protic solvent/polar aprotic solvent solution may be degassed. The polar protic solvent/polar aprotic solvent solution may be ethanol/THF solution. The ratio of the ethanol/THF solution may be v/v: 1/1.

The polymerization reaction may be stirred at a temperature of about 60 to about 90° C., about 60 to about 80° C., about 60 to about 75° C., about 60 to about 70° C., about 60 to about 65° C., about 65 to about 90° C., about 70 to about 90° C., about 75 to about 90° C. or about 80 to about 90° C. The polymerization reaction may be stirred at a temperature of about 75° C. The polymerization reaction may be stirred for about 20 to about 28 hours, about 20 to about 27 hours, about 20 to about 26 hours, about 20 to about 25 hours, about 20 to about 24 hours, about 20 to about 23 hours, about 20 to about 22 hours, about 20 to about 21 hours, about 21 to about 28 hours, about 22 to about 28 hours, about 23 to about 28 hours, about 24 to about 28 hours, about 25 to about 28 hours, about 26 to about 28 hours or about 27 to about 28 hours. The polymerization reaction may be stirred for about 24 hours.

The polar aprotic solvent that is used to dilute the reaction condition may be THF. The reaction mixture may be exposed to ambient atmosphere for about 30 to about 90 minutes, about 30 to about 80 minutes, about 30 to about 70 minutes, about 30 to about 60 minutes, about 30 to about 50 minutes, about 30 to about 40 minutes, about 40 to about 90 minutes, about 50 to about 90 minutes, about 60 to about 90 minutes, about 70 to about 90 minutes or about 80 to about 90 minutes. The reaction mixture may be exposed to ambient atmosphere for about 60 minutes. The short column may be a neutral aluminium oxide column. The aqueous solution may be water. The resulting solutions may be dialyzed against water for about one to three days, about one to two days or about two days.

The core-shell nanoparticle may be prepared by grafting the copolymer onto the inorganic core between the halo alkyl groups and the heteroaryl groups of the pH-responsive block. The core-shell nanoparticle may be prepared by conjugating the copolymer onto the surface functionalized inorganic core. The silanized inorganic core may be incubated in a solution of the copolymer in a polar aprotic solvent for a period of time and then the collected particles may be put in a vacuum oven at a temperature for a period of time to enable sufficient quaternization between the halo alkyl groups and the heteroaryl groups of the copolymers. The unconjugated copolymers may be removed by washing with copious amount of polar aprotic solvent.

The incubation step may occur for about 10 to about 30 minutes, about 10 to about 20 minutes, about 20 to about 30 minutes or about 20 minutes. The vacuum oven temperature may be in the range of about 100 to about 140° C., about 100 to about 130° C., about 100 to about 120° C., about 100 to about 110° C., about 110 to about 140° C., about 120 to about 140° C. or about 130 to about 140° C. The vacuum oven temperature may be about 120° C. The collected particles may be dried in the vacuum oven for about 10 to about 14 hours, about 10 to about 13 hours, about 10 to about 12 hours, about 10 to about 11 hours, about 11 to about 14 hours, about 12 to about 14 hours or about 13 to about 14 hours. The collected particles may be put in a vacuum oven for about 12 hours. The halo alkyl groups of the triblock copolymers may be the iodoalkyl groups. The heteroaryl groups of the triblock copolymers may be the pyridine groups. The polar aprotic solvent may be THF.

Exemplary, non-limiting embodiments of use of a core-shell nanoparticle will now be disclosed.

There is provided use of a core-shell nanoparticle to remove oil and surfactant in an oil-in-water nanoemulsion, wherein said core-shell nanoparticle comprises (a) an inorganic core comprising a nanoparticle comprising a metal, a metal oxide or combination thereof, and a silica component; (b) a shell material comprising a copolymer having at least two polymers selected from a pH-responsive polymer and a hydrophobic polymer; and (c) a crosslinker that conjugates the shell material to the inorganic core. The core-shell nanoparticle may be as described above.

The pH-responsive block of the copolymer may be a weak polybase and may be able to alter its wettability via protonation and deprotonation of the heteroaryl groups if the pH level changes. Based on the pH and magnetic responsiveness, the prepared core-shell nanoparticle may be employed to selectively collect oil droplets from surfactant-free oil-in-water emulsions and control the transport of the oil phase under a magnetic field. The external magnetic field may be from a magnet. The magnet may be used to remotely control the separation of oil from the oil-in-water nanoemulsion by using the core-shell nanoparticle. At an appropriate pH level, the magnet may also be used in the subsequent separation of the core-shell nanoparticle from the oil-absorbed core-shell nanoparticle mixtures.

Exemplary, non-limiting embodiments of a method of removing oil and surfactant in an oil-in-water nanoemulsion by using a core-shell nanoparticle will now be disclosed.

The method of removing oil and surfactant in an oil-in-water nanoemulsion may comprise the steps of (a) mixing a core-shell nanoparticle in the oil-in-water nanoemulsion; (b) adjusting the pH of the nanoemulsion to thereby trap the oil in the nanoemulsion on the surface of the core-shell nanoparticle; and (c) applying an external magnetic field to separate the core-shell nanoparticle with entrapped oil from the water in the nanoemulsion, wherein said core-shell nanoparticles comprises (i) an inorganic core comprising a nanoparticle comprising a metal, a metal oxide or combination thereof, and a silica component; (ii) a shell material comprising a copolymer having at least two polymers selected from a pH-responsive polymer and a hydrophobic polymer; and (iii) a crosslinker that conjugates the shell material to the inorganic core

The oil and surfactant in the oil-in-water nanoemulsion may be removed by using a core-shell nanoparticle comprising the steps of: mixing the core-shell nanoparticle in the oil-in-water nanoemulsion, adjusting the pH of the nanoemulsion to cause the core-shell nanoparticle to be hydrophobic to allow the oil in the nanoemulsion to be trapped on the surface of the core-shell nanoparticle, and applying an external magnetic field to separate the core-shell nanoparticle with entrapped oil from water in the nanoemulsion.

The pH that can be used depends on the type of pH responsive polymer used and would be a pH that can cause deprotonatation of the pH responsive polymer, leading to the pH responsive polymer becoming oleophilic or hydrophobic. In this manner, the core-shell nanoparticle may be deemed as being hydrophobic as well, due to this property being attributed to the pH responsive polymer. When the pH of the nanoemulsion is adjusted to a suitable pH such as 7, the heteroaryl groups of the pH-responsive block become deprotonated and oleophilic, and upon contact with oil, the core-shell nanoparticle can trap the oil onto their surface due to the superoleophilic nature of the pH responsive polymer (and consequently, the core-shell nanoparticle). When an external magnetic field is applied, the oil trapped on the surface of the core-shell nanoparticles can be easily separated from water due to the inorganic core which is made from metal and/or metal oxide. The heteroaryl groups of the pH-responsive block may be pyridyl groups of the pH-responsive block.

Exemplary, non-limiting embodiments of a method of separating oil from an oil-absorbed core-shell nanoparticle will now be disclosed.

The method of separating oil from an oil-absorbed core-shell nanoparticle may comprise the steps of (a) immersing the oil-absorbed core-shell nanoparticle into a solution of acid; and (b) washing the oil off the surface of the oil-absorbed core-shell nanoparticle with an aqueous solution at neutral pH, wherein said core-shell nanoparticles comprises (i) an inorganic core comprising a nanoparticle comprising a metal, a metal oxide or combination thereof, and a silica component; (ii) a shell material comprising a copolymer having at least two polymers selected from a pH-responsive polymer and a hydrophobic polymer; and (iii) a crosslinker that conjugates the shell material to the inorganic core.

The oil from the oil-absorbed core-shell nanoparticle may be separated by immersing the oil-absorbed core-shell nanoparticle into a solution of acid. When the core-shell nanoparticle is immersed into the acidic solution, the pH responsive polymer may protonate and acquire a hydrophilic property. This thus reverses the hydrophobicity property of the pH responsive polymer (and consequently, the core-shell nanoparticle becomes hydrophilic). The pH of the acid solution depends on the type of pH responsive polymer used. The pH may be 3. The oil may be washed off the surface of the oil-absorbed core-shell nanoparticle with the aqueous solution at neutral pH. Thus, the captured oil may be easily washed from the surface of the core-shell nanoparticle with water.

Advantageously, the core-shell nanoparticle may be recyclable after the method of separating oil from an oil-absorbed core-shell nanoparticle. The core-shell nanoparticle may be recycled at least three times.

### BRIEF DESCRIPTION OF DRAWINGS

The accompanying drawings illustrate a disclosed embodiment and serves to explain the principles of the disclosed embodiment. It is to be understood, however, that the drawings are designed for purposes of illustration only, and not as a definition of the limits of the invention.

FIG. 1 shows a series of transmission electron microscopy (TEM) images of Fe₃O₄ (FIG. 1A), Fe₃O₄@SiO₂ (FIG. 1B) and Fe₃O₄@SiO₂@P4VP-PDMS-P4VP nanoparticles (FIG. 1C) (scale bar 20 nm).

FIG. 2 shows a series of FTIR spectra of Fe₃O₄(FIG. 2A), Fe₃O₄@SiO₂ (FIG. 2B), PDMS-diBr (FIG. 2C), P4VP-PDMS-P4VP (FIG. 2D), and Fe₃O₄@SiO₂@P4VP-PDMS-P4VP nanoparticles (FIG. 2E).

FIG. 3 shows a series of ¹H NMR spectra of Br-PDMS-Br in CDCl₃ (FIG. 3A) and P4VP-PDMS-P4VP in DMSO-d₆/CDCl₃ (2/1, v/v) (FIG. 3B). The chemical structures of both polymers are given at the top of the spectrum. Residual solvent peaks are labelled with stars.

FIG. 4 shows a series of TGA curves for Fe₃O₄@SiO₂ (curve A), ITMS activated Fe₃O₄@SiO₂ (curve B), Fe₃O₄@SiO₂@P4VP-PDMS-P4VP nanoparticles (curve C), and P4VP-PDMS-P4VP triblock copolymer (curve D).

FIG. 5 shows a series of magnetic hysteresis loops for Fe₃O₄, (loop A), Fe₃O₄@SiO₂ nanoparticle (loop B) and Fe₃O₄@SiO₂@P4VP-PDMS-P4VP hybrid nanoparticles (loop C).

FIG. 6 shows the diameter distribution of Fe₃O₄@SiO₂@P4VP-PDMS-P4VP nanoparticles at pH 3 and 7, respectively.

FIG. 7 demonstrates a series of the modifications of the remote controlled oil-in-water nanoemulsion separation. FIG. 7A is a schematic diagram showing the overall process of absorbing and releasing oil from an oil-in-water nanoemulsion. FIG. 7B shows a series of the changes of the remote controlled oil-in-water nanoemulsion separation by the combination effect of pH-responsive and magnetic hybrid nanoparticles and the subsequent separation of hybrid nanoparticles from the obtained oil/nanoparticles mixtures (FIG. 7C).

FIG. 8 shows a series of UV-Vis spectra of oil-in-water nanoemulsions (line A) and after treatment with P4VP-PDMS-P4VP copolymers (line B), Fe₃O₄@SiO₂ (line C) and Fe₃O₄@SiO₂@P4VP-PDMS-P4VP nanoparticles (line D).

FIG. 9 shows a series of the diameter distribution of oil-in-water nanoemulsion (FIG. 9A) and after treatment with P4VP-PDMS-P4VP copolymers (FIG. 9B), Fe₃O₄@SiO₂ (FIG. 9C) and Fe₃O₄@SiO₂@P4VP-PDMS-P4VP nanoparticles (FIG. 9D). Insert images showing the corresponding samples used for dynamic light scattering (DLS) measurements. FIG. 9B and FIG. 9C have the same x-axis (diameter in nm) as FIG. 9A.

FIG. 10 shows the dipole value calculations of the optimized unit structure of P4VP-PDMS-P4VP triblock copolymer at pH=7 (FIG. 10A) and pH=3 (FIG. 10B). FIG. 10C shows the hydrogen bond between a H₂O molecule and a pyridyl group in protonated P4VP-PDMS-P4VP at pH=3.

FIG. 11 shows a series of images where FIG. 11A shows the pristine oil-in-water nanoemulsion (bottle A) and after treatments with Fe₃O₄@SiO₂@P4VP-PDMS-P4VP nanoparticles for 1-3 cycles (bottles B to D). FIG. 11B shows the optical transmittance of the corresponding solutions (bottles A to D) at 500 nm (*P<0.001).

### DETAILED DESCRIPTION OF DRAWINGS

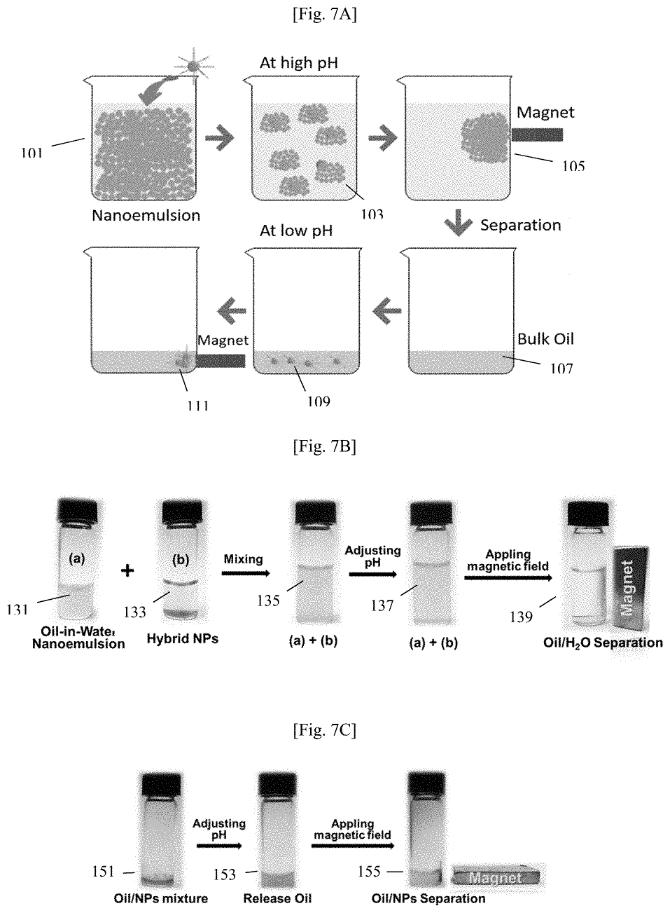

Referring to FIG. 7, FIG. 7A shows a schematic diagram of the overall process of the remote controlled separation of oil-in-water nanoemulsion by the combination effect of pH-responsive and magnetic core-shell hybrid nanoparticles, and the subsequent separation of hybrid nanoparticles from the obtained oil/nanoparticles mixtures under a magnetic field. Oil-in-water nanoemulsion with the hybrid nanoparticles (101) were prepared and at high pH (of 7), the pH-responsive polymer blocks were in the deprotonated state and exhibited oleophilic properties, while the hydrophobic polymer block is more hydrophobic than the pH-responsive polymer blocks. Therefore, the oleophilic and hydrophobic surfaces of the hybrid nanoparticles had a high affinity to the oil in the oil-in-water nanoemulsion. Hence, the hybrid nanoparticles congregated together upon contact with the oil and the hybrid nanoparticles can trap the oil onto their surface due to the surface's superoleophilic nature (103). When an external magnetic field was applied, the oil trapped on the surface of hybrid nanoparticles can be easily separated from the water (105). The oil captured on the surface of the hybrid nanoparticles was then released (107) by placing the hybrid nanoparticles into acid water having a pH value (such as pH of 3) (109). When contacted with acidic water, most of the pH-responsive functional groups on the pH-responsive polymer blocks became protonated and the surface acquired hydrophilic property. Thus, the captured oil can be easily washed from the surface of the hybrid nanoparticles and can be separated from the hybrid nanoparticles by using an external magnetic field (111).

### EXAMPLES

Non-limiting examples of the invention will be further described in greater detail by reference to specific Examples, which should not be construed as in any way limiting the scope of the invention.

List of Abbreviations Used

Ar: argon

4-VP: 4-vinyl pyridine

bs: broad signal (broad peak)¹H NMR

cat.: catalyst

CuBr: copper(I) bromide

DCM or CH₂Cl₂: dichloromethane or methylenechloride

DI: deionized water

FTIR: fourier transform infrared

H: hour(s)

HPLC: high pressure liquid chromatography

HBr: hydrobromic acid

IPTMS: 3-iodopropyl trimethoxysilane

L: litre(s)

LC-MS: Liquid chromatography-mass spectrometry

MgSO₄: magnesium sulfate

m.p.: melting point

min: minute(s)

MS: mass spectrometry

NPs: nanoparticles

NMR: Nuclear Magnetic Resonance

PMDETA: N,N,N′,N″,N″-pentamethyldiethylenetriamine

Rt: room temperature

NaHCO₃: sodium bicarbonate

TEOS: tetraethyl orthosilicate

THF: tetrahydrofuran

NEt₃: triethylamine

TLC: thin layer chromatography

### Materials and Methods

Octadecene (>99%), Oleic Acid (>99.9%), IGEPAL CO-520, cyclohexane, toluene (anhydrous, 99.8%), copper(I) bromide (CuBr, 99%), tetrahydrofuran (THF, anhydrous, 99.9%), iron(III) acetylacetonate, cyclohexene (anhydrous, 95%), ethanol (>99.8%), ethylenediamine (>99%), isopropyl alcohol (>99.8%), ammonium hydroxide (28 wt %), tetraethyl orthosilicate (TEOS, 99.999% trace metals basis), magnesium sulfate (MgSO₄, >97%), poly(dimethylsiloxane), bis(3-aminopropyl) terminated (Mₙ=2500 g/mol), 2-bromoisobutyryl bromide (98%), N,N,N′,N″,N″-pentamethyldiethylenetriamine (PMDETA, 99%), (3-iodopropyl) trimethoxysilane (IPTMS, >95%), 4-vinyl pyridine (4VP, >95%) were purchased from Sigma-Aldrich Corp. (St. Louis, Mo., U.S.A.) and were used as received. All other reagents were used as received, except where otherwise noted in the experimental text below. All anhydrous solvents were also purchased from Sigma-Aldrich Corp. (St. Louis, Mo., U.S.A.) and used without further purification.

Nuclear magnetic resonance (¹H NMR) spectra were recorded on a Bruker AV-400 NMR spectrometer at room temperature. Chemical shifts were recorded in parts per million (ppm) in reference to the solvent peaks of CHCl₃ ((δ7.3 ppm) and DMF ((δ8.03, 2.92 and 2.75 ppm). ¹H NMR data are reported in the following order: chemical shift, multiplicity (br=broad, s=singlet, d=doublet, t=triplet, q=quartet and m=multiplet), integration and assignment. Transmission electron microscopy (TEM) images were obtained on a high-resolution transmission electron microscope (JEOL 2100-JEOL Ltd., Tokyo, Japan). The samples were suspended in ethanol and supported onto 200 mesh copper grids before measurement, which were coated in advance with supportive Formvar films and carbon (Agar Scientific Ltd, Stansted, Essex, United Kingdom). Dynamic light scattering (DLS) were performed using a Brookhaven BI-200SM multi-angle goniometer equipped with a BI-APD detector (Brookhaven Instruments Corporation, Holtsville, N.Y., U.S.A). The light source was a 35 mW He-Ne laser emitting vertically polarized light of 632.8 nm wavelength. Fourier transform infrared (FTIR) spectra were performed using Perkin-Elmer Spectrum 2000 (PerkinElmer, Inc. Waltham, Mass., U.S.A). The data were collected in the range of 400 to 4000 cm⁻¹ with a resolution of 4 cm⁻¹ and a scan number of 64 at room temperature. Wide-angle x-ray diffraction (WXRD) patterns of powder samples were obtained using a D8 Advance X-ray diffractometer (Bruker, AXS Inc., Madison, Wis., U.S.A), using Ni-filtered Cu Kα of λ=1.5418 Å operated at 40 kV and 40 mA with a step size of 0.004° and step duration of 1 second. The magnetic properties of the as-synthesized nanoparticles were measured using a vibrating sample magnetometer (VSM, Lakeshore, Model 665 (Lake Shore Cryotronics, Ohio, U.S.A.). Thermogravimetric analysis (TGA) measurements were performed on a TA Q500 (TA Instruments, Delaware, U.S.A). All samples were equilibrated at 100° C. to remove any volatile solvent and moisture. The samples were then heated to 800° C. at 20° C./min under nitrogen at a flow rate of 60 mL/min.

### Density Functional Theory (DFT)

Density functional theory calculations were performed to further understand the working mechanism of Fe₃O₄@SiO₂@P4VP-PDMS-P4VP hybrid nanoparticles at different pH values. All the calculations were carried out with Gaussian 091 at m062x/6-31G(d) level. Utilizing the rule of miscibility which indicates that good miscibility is influenced by the polarity, we calculated the dipole of P4VP-PDMS-P4VP at pH=7 and pH=3, respectively with the converged structure, and further use the dipole value to estimate the polarity of P4VP-PDMS-P4VP copolymers and its interaction with oil and water molecules.

### Example 1

An oil absorber based on pH-responsive block copolymer modified magnetic nanoparticles was constructed for effective separation of oil-in-water emulsion. The fabrication of core-shell Fe₃O₄@SiO₂@P4VP-PDMS-P4VP magnetic nanoparticle is schematically shown below in Scheme 1. The superparamagnetic Fe₃O₄ nanoparticles was designed as the core materials for providing the separation force, and surface modification with poly(4-vinylpyridine-b-dimethyl siloxane-b-4-vinylpyridine) (P4VP-PDMS-P4VP) block copolymer was performed to supply the switchable oil wettability properties. These hybrid nanoparticles showed excellent separation performance and could absorb octadecene up to 78.2 times of their own weight. It can be envisioned that this recyclable formulation should have great potential for practical applications in oily wastewater treatment.

According to Scheme 1, a silica layer was first coated on the surface of the Fe₃O₄ magnetic nanoparticles. Then, the formed Fe₃O₄@SiO₂ nanoparticles were immersed in an anhydrous toluene solution of IPTMS to functionalize the surface with iodopropyl groups via silanization, which acted as an intermediate anchoring layer for the block copolymer grafting. Finally, the triblock copolymers P4VP-PDMS-P4VP were coated on the Fe₃O₄@SiO₂ nanoparticles via quaternization between the iodopropyl groups and the pyridyl groups on the P4VP blocks, yielding a layer of the grafted block copolymer.

### Example 2—Preparation of Fe₃O₄@SiO₂@P4VP-PDMS-P4VP Hybrid Nanoparticles (NPs) Synthesis of Magnetite Fe₃O₄ Nanoparticles

In a typical procedure, 2.5 mmol of iron (III) acetylacetonate (Fe(acac)₃) and 20 mmol of oleic acid (OA) are added into a 100 mL tri-neck round bottom flask (RBF) containing 12.8 mL of octadecene. First, the resulting mixture was heated to 160° C. for 30 minutes under argon purging. After that, the reactant was further heated to 320° C. at a rate of 5° C./minutes for another 60 minutes. The mixture was then cooled down to room temperature, and the final product was collected by centrifuging and washing by a standard hexane/isopropanol approach for 3 times.

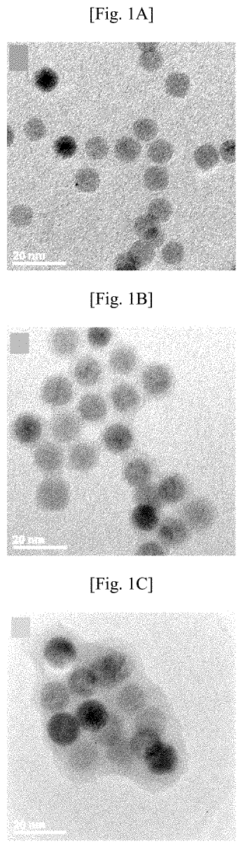

The Fe₃O₄ magnetic nanoparticles were prepared via the solvothermal method. The TEM images of the morphology and size of the nanoparticles are shown in FIG. 1A. It can be observed that the prepared Fe₃O₄ nanoparticles take nearly uniform spherical shapes with a mean diameter of about 10 nm.

Synthesis and Surface Functionalization of Fe₃O₄@SiO₂ Nanoparticles (NPs)

For the preparation of Fe₃O₄@SiO₂ nanoparticles, 100 mg of Fe₃O₄ particles dispersed in 5.0 mL were added into a conical flask containing 7.5 g of IPEGAL CO-520 and 12.5 mL of cyclohexane, and the mixtures were stirred vigorously at room temperature for 60 minutes. Then, ammonia solution (150 uL, 28 wt %) was added to form a brownish reverse microemulsion solution. After further stirring for 60 minutes, 250 uL of tetraethyl orthosilicate (TEOS) was added and the reaction was aged overnight. The final product was collected by centrifugation and washed with water/ethanol mixture for 3 times.

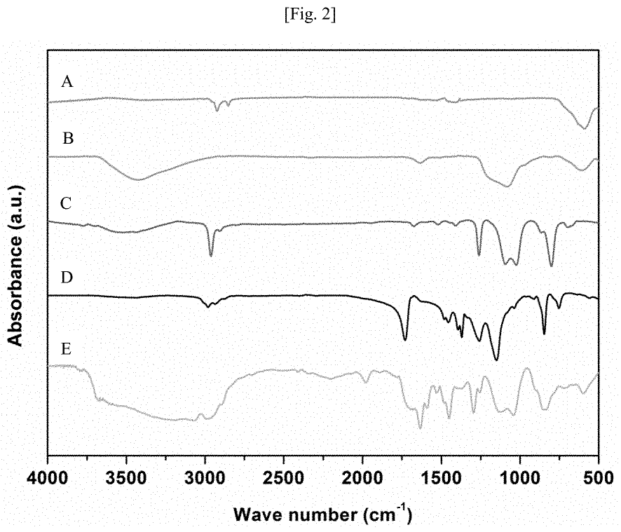

For the purpose of preventing aggregation and facile surface functionality, a silica coating on Fe₃O₄ nanoparticles was performed. Furthermore, the inert surface of silica layer can prevent Fe₃O₄ core from corrosion under any acid circumstances. After the reaction was completed, the size of the nanoparticles increased and the light silica layer can be observed clearly, as shown in FIG. 1B. Further, the successful silica coating onto Fe₃O₄ nanoparticles was confirmed by FT-IR technique where the characteristic absorption bonds at 1080 cm⁻¹ assigned to the Si—O—Si vibrations can be clearly seen in the spectrum of Fe₃O₄@SiO₂ nanoparticles (FIG. 2B) unlike the spectrum of Fe₃O₄ nanoparticles, as indicated in FIG. 2A.

The surface of Fe₃O₄@SiO₂ nanoparticles was further functionalized with iodoalkyl groups via silanization. Typically, 50 mg of Fe₃O₄@SiO₂ particles dispersed in 15 mL of anhydrous toluene were mixed with 1.5 mL of (3-iodopropyl) trimethoxysilane (IPTMS) and stirred for 12 hours at room temperature. The silanized Fe₃O₄@SiO₂ nanoparticles were then washed with toluene and ethanol twice to remove the unreacted silanes, followed by drying with a flow of nitrogen. The surface functionalized Fe₃O₄@SiO₂ nanoparticles were dispersed in anhydrous THF for further preparation of multifunctional hybrid nanoparticles.

### Preparation of P4VP-PDMS-P4VP Triblock Copolymer

The triblock copolymer P4VP-PDMS-P4VP was synthesized according to the procedure as shown in Scheme 2. The triblock copolymers were prepared by atomic transfer radical polymerization (ATRP). PDMS-diBr was used as macroinitiator to polymerize 4-VP by ATRP to produce the triblock copolymer P4VP-PDMS-P4VP.

Firstly, poly(dimethylsiloxane) (PDMS) was modified into ATRP macroinitiator PDMS-diBr by esterification of its amino end group with 2-bromoisobutyryl bromide in anhydrous CH₂Cl₂. A 5 times excess of 2-bromoisobutyryl bromide with respect to —NH₂ end groups was added and triethylamine was used to trap hydrobromic acid (HBr) generated during the reaction. The reactants were stirred at room temperature for 24 hours and the resultant solution was then washed three times using 100 mL of aqueous sodium bicarbonate solution. The organic layer was then isolated and dried with anhydrous MgSO₄ over 4 hours and filtered, followed by vacuum drying at 40° C. overnight. The yield of the product (PDMS-diBr) is 94%.

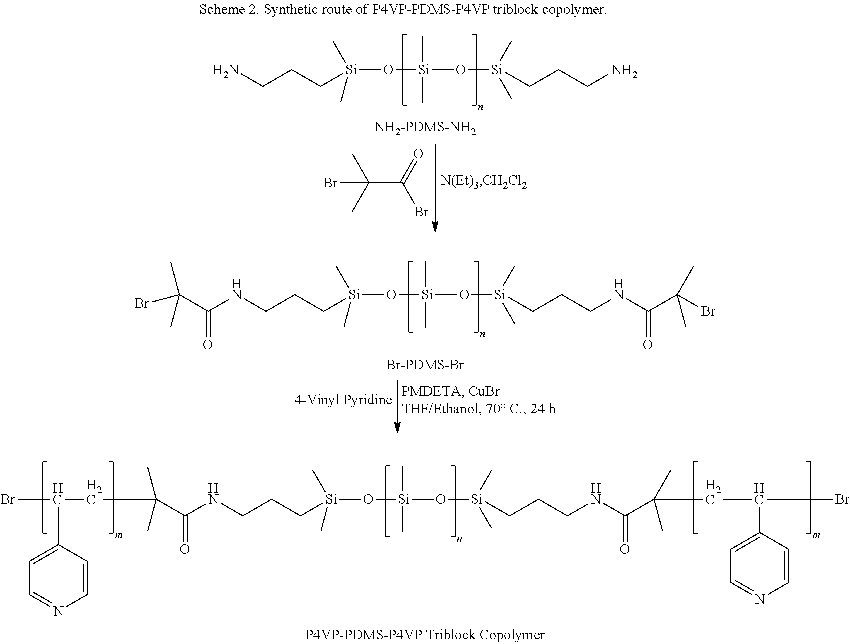

For the synthesis of P4VP-PDMS-P4VP triblock copolymer, 0.56 g of PDMS-diBr, 72.8 mg of PMDETA and 2.28 g of 4-VP were introduced into a 25 mL Schlenk tube, sealed with rubber plug. Next, the tube was purged and refilled with nitrogen three times using the vacuum-nitrogen-circling system. 57.6 mg of CuBr and 5.0 mL of degassed ethanol/THF solution (v/v: 1/1) were quickly added into the tube under a nitrogen atmosphere. Polymerization was allowed to proceed under continuous stirring at 75° C. for 24 hours. The reaction was stopped by diluting the reaction mixture with THF and exposing it to ambient atmosphere for 1 hour. Copper complex was removed by passing the reaction mixture through a short neutral aluminium oxide column. After concentrating the filtrates, the solutions were dialyzed against water for two days followed by freeze drying to obtain the titled compound.

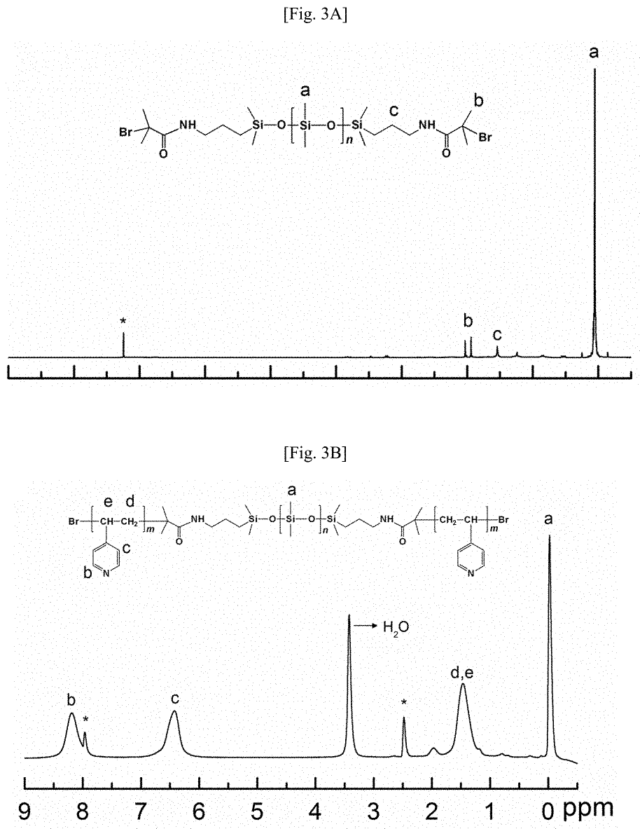

The chemical structure of the titled copolymer P4VP-PDMS-P4VP was confirmed by ¹H NMR spectroscopy. As compared with the ¹H NMR spectrum of PDMS-diBr (FIG. 3A), the respective characteristic peaks for methylene and methine protons at 1.48 ppm and for pyridine ring protons at 6.49 and 8.25 ppm of P4VP blocks can be seen clearly (FIG. 3B), indicating that PDMS-diBr successfully initiated polymerization of 4-VP monomers.

In addition, FT-IR spectroscopy shown in FIG. 2D, provides further evidence for the successful formation of the triblock copolymer P4VP-PDMS-P4VP, where the absorption peaks at 1690, 1451 and 1415 cm⁻¹ were corresponding to the pyridine ring vibration, as compared to PDMS-diBr as indicated in FIG. 2C.

Preparation of Fe₃O₄@SiO₂@P4VP-PDMS-P4VP Hybrid Nanoparticles (NPs)

Fe₃O₄@SiO₂@P4VP-PDMS-P4V hybrid nanoparticles were prepared by grafting or conjugating the P4VP-PDMS-P4VP triblock copolymers onto surface functionalized Fe₃O₄@SiO₂ nanoparticles via quaternization between the iodopropyl groups and the pyridyl groups on the P4VP blocks.

Typically, 50 mg of silanized Fe₃O₄@SiO₂ nanoparticles were incubated with 5.0 mg/mL P4VP-PDMS-P4VP polymer solution in anhydrous THF for 20 minutes, and then the collected particles were put in a vacuum oven at 120° C. for 12 hours to enable sufficient quaternization between the iodoalkyl groups and the pyridine groups of the block copolymers. The unconjugated P4VP-PDMS-P4VP polymers were removed by washing with copious amount of THF.

In the TEM image of Fe₃O₄@SiO₂@P4VP-PDMS-P4VP hybrid nanoparticles as shown in FIG. 1C, the outer shell of the grafted block copolymers can be seen clearly, indicating that the grafting was successful. The formed Fe₃O₄@SiO₂@P4VP-PDMS-P4VP hybrid nanoparticles were also examined by TGA and FT-IR techniques. The FT-IR spectrum as shown in FIG. 2E demonstrated that Fe₃O₄@SiO₂@P4VP-PDMS-P4VP hybrid nanoparticles were synthesized accordingly. The characteristic absorption peaks belonging to the copolymer P4VP-PDMS-P4VP appeared clearly as compared with the inorganic Fe₃O₄@SiO₂ (FIG. 2B), further demonstrating the successful conjugation of the copolymer P4VP-PDMS-P4VP onto the surface of the Fe₃O₄@SiO₂ core.

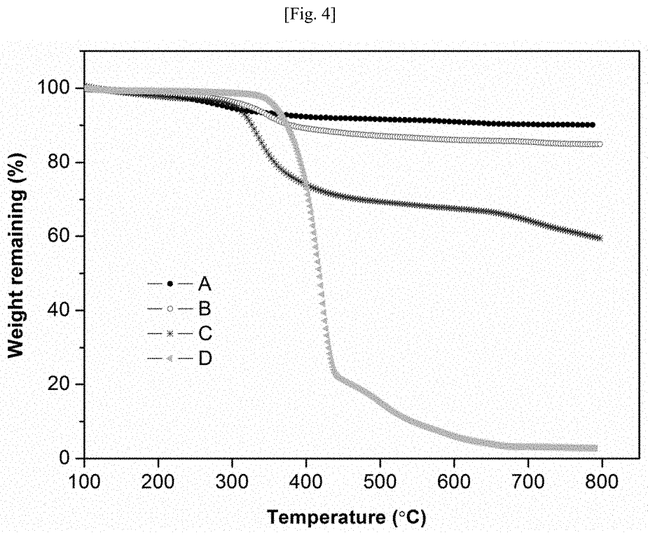

As shown in FIG. 4, native Fe₃O₄@SiO₂ nanoparticles and ITMS activated Fe₃O₄@SiO₂ nanoparticles have a tiny weight loss from the temperature of 100° C. to 800° C., while a step-wise degradation profile (clear stage) was found in the TGA curve of the Fe₃O₄@SiO₂@P4VP-PDMS-P4VP hybrid nanoparticles (curve C) by contrast. The weight loss at above 300° C. can be attributed to the cleaving of the P4VP-PDMS-P4VP copolymers. Based on the TGA analysis, the weight ratio between the inorganic Fe₃O₄@SiO₂ core and P4VP-PDMS-P4VP layer was evaluated to be approximately at 62:38.

### Example 3

Magnetic Properties of Fe₃O₄@SiO₂@P4VP-PDMS-P4VP Hybrid Nanoparticles (NPs)

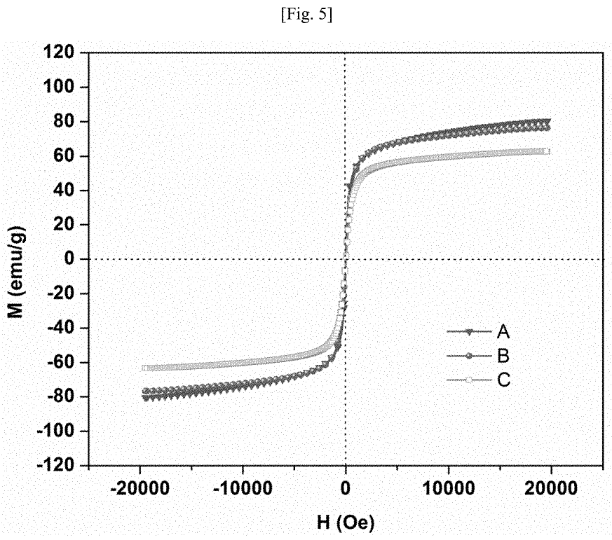

The magnetic properties of the Fe₃O₄@SiO₂@P4VP-PDMS-P4VP hybrid nanoparticles were investigated using the vibrating sample magnetometer (VSM) technique at room temperature. FIG. 5 shows the magnetization curves/loops of pure Fe₃O₄ nanoparticle (loop A), Fe₃O₄@SiO₂ nanoparticle (loop B) and Fe₃O₄@SiO₂@P4VP-PDMS-P4VP hybrid nanoparticles (loop C). It was found that Fe₃O₄@SiO₂@P4VP-PDMS-P4VP hybrid nanoparticles were superparamagnetic since neither remanence nor coercivity was detected when the magnetic field was removed. The behavior of these hybrid nanoparticles no longer show the magnetic interactions, which means that there are reduced aggregations between them. The mean magnetization saturation (Ms) value of Fe₃O₄ is 78.0 emu/g, which is similar to previous reports. The Ms of the hybrid nanoparticles was normalized with the mass of Fe₃O₄ cores based on the weight ratios evaluated from the TGA thermogram. The normalized Ms of the Fe₃O₄@SiO₂@P4VP-PDMS-P4VP hybrid nanoparticles is 64.5 emu/g. Therefore, no obvious loss of Ms was observed between the hybrid nanoparticles and the bare Fe₃O₄ nanoparticles. This result indicates that the polymeric shell did not affect/influence the magnetic properties of Fe₃O₄ nanoparticles significantly.

PH-Responsiveness of Fe₃O₄@SiO₂@P4VP-PDMS-P4VP Hybrid Nanoparticles (NPs)

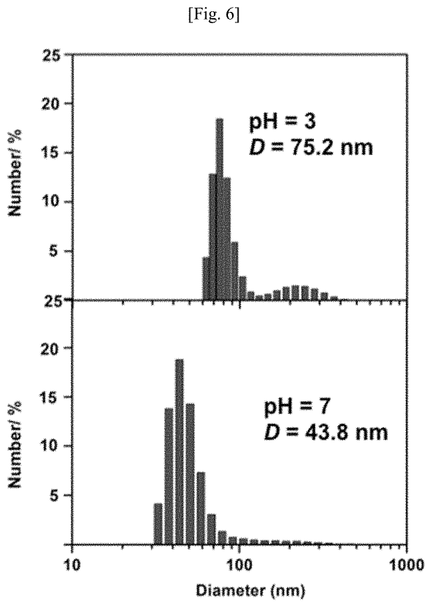

The pH-responsiveness of the Fe₃O₄@SiO₂@P4VP-PDMS-P4VP hybrid nanoparticles was investigated by dynamic light scattering (DLS). From FIG. 6, it was found that the mean hydrodynamic radius of the nanoparticles increase from 43.8±3.6 nm to 75.2±5.3 nm when the neutral pH is reduced to a value of 3. This phenomenon could be attributed to the fact that P4VP segments in Fe₃O₄@SiO₂@P4VP-PDMS-P4VP hybrid nanoparticles were protonated at lower pH and subsequently swelled due to the electrostatic repulsion between the charged P4VP segments.

### Example 4

### Preparation of Oil-in-Water Nanoemulsions and Separation Efficiency Assay

Oil-in-water nanoemulsions were prepared by adding octadecene (1.0 mL) stained with oil red O to the mixture of sodium dodecyl sulfate (0.1 mg) and deionized (DI) water (50 mL) under stirring for 1 day. Then, it was diluted 10× before mixing with Fe₃O₄@SiO₂@P4VP-PDMS-P4VP hybrid nanoparticles for separation efficiency assay.

### Controlled Oil/Water Separation

Based on the pH and magnetic responsiveness, the prepared Fe₃O₄@SiO₂@P4VP-PDMS-P4VP hybrid nanoparticles can be employed to selectively collect oil droplets from surfactant-free oil/water emulsions and control the transport/movement of the oil phase under a magnetic field. A schematic diagram of the overall process of absorbing and releasing oil from an oil-in-water nanoemulsion is shown in FIG. 7A. In particular, FIG. 7B shows the process of the remote controlled separation of oil-in-water nanoemulsion by the combination effect of pH-responsive and magnetic hybrid nanoparticles, and the subsequent separation of hybrid nanoparticles from the obtained oil/nanoparticles mixtures under a magnetic field as indicated in FIG. 7C. Here, the hybrid nanoparticles of FIG. 7A is Fe₃O₄@SiO₂@P4VP-PDMS-P4VP hybrid nanoparticles, the pH-responsive polymer blocks in FIG. 7A is P4VP while the hydrophobic polymer block in FIG. 7A is PDMS. FIG. 7B shows a series of pictures depicting the process where the oil-in-water nanoemulsion was prepared using the oil red O and the color of the nanoemulsion is pink (131). The hybrid nanoparticles solution in light yellow (133) were prepared accordingly, and both nanoemulsion and hybrid nanoparticles were mixed together to achieve the mixture of nanoemulsion and hybrid nanoparticles in an orange-pink colour solution, as shown as 135. The pH level was adjusted to pH 7 (as described above), where the P4VP and PDMS segments become superoleophilic nature (their surfaces) and able to trap the oil onto their surfaces of the nanoparticles (137). By applying the external magnetic field, the oil trapped on the surface of nanoparticles can be easily separated from the water (139). FIG. 7C shows the subsequent separation of hybrid nanoparticles from the obtained oil/nanoparticles mixtures (151), where the pH level was adjusted to 3 (as described above). Due to the pyridyl groups (being the pH-responsive functional group of the pH-responsive polymer blocks) on the P4VP segments that became protonated, the surfaces of the nanoparticles acquired the hydrophilic property and thus, release the captured oil (153). By applying the external magnetic field, the hybrid nanoparticles were separated from the oil (155).

P4VP, which is a weak polybase has a pH-responsive property that can alter its wettability via protonation and deprotonation of the pyridyl groups if there is a change in the surrounding pH values. When the Fe₃O₄@SiO₂@P4VP-PDMS-P4VP hybrid nanoparticles were mixed with the oil-in-water nanoemulsion with a pH of 7, the P4VP segments were in the deprotonated state and exhibited oleophilic properties. Meanwhile, the flexible PDMS segment is more hydrophobic than the P4VP segments. As a consequence, the oleophilic and hydrophobic surface of the hybrid nanoparticles had a high affinity to the oil in the oil-in-water nanoemulsion with a pH of 7. Upon contact with the oil, Fe₃O₄@SiO₂@P4VP-PDMS-P4VP hybrid nanoparticles can trap the oil onto their surface due to the surface's superoleophilic nature. When an external magnetic field was applied, the oil trapped on the surface of nanoparticles can be easily separated from the water. The oil captured on the surface of the Fe₃O₄@SiO₂@P4VP-PDMS-P4VP hybrid nanoparticles was then released by placing the nanoparticles into acid water having a pH value of 3. When contacting with acidic water, most of the pyridyl groups on the P4VP segments became protonated and the surface acquired hydrophilic property. Thus, the captured oil can be easily washed from the surface of the Fe₃O₄@SiO₂@P4VP-PDMS-P4VP hybrid nanoparticles. The efficiency of the Fe₃O₄@SiO₂@P4VP-PDMS-P4VP hybrid nanoparticles for controlled oil/water separation was tested using UV and DLS techniques.

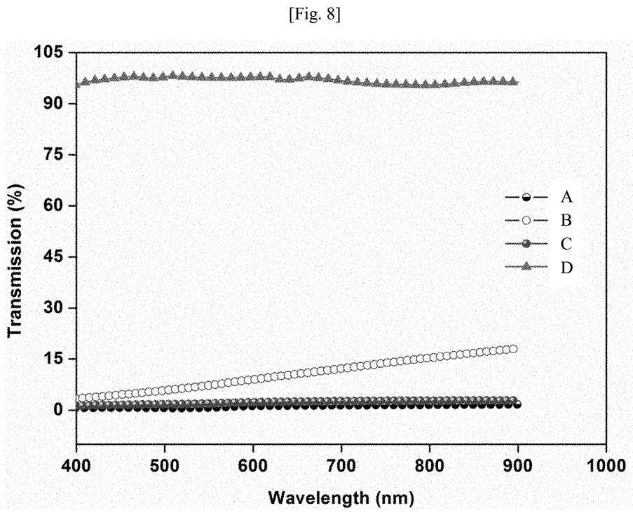

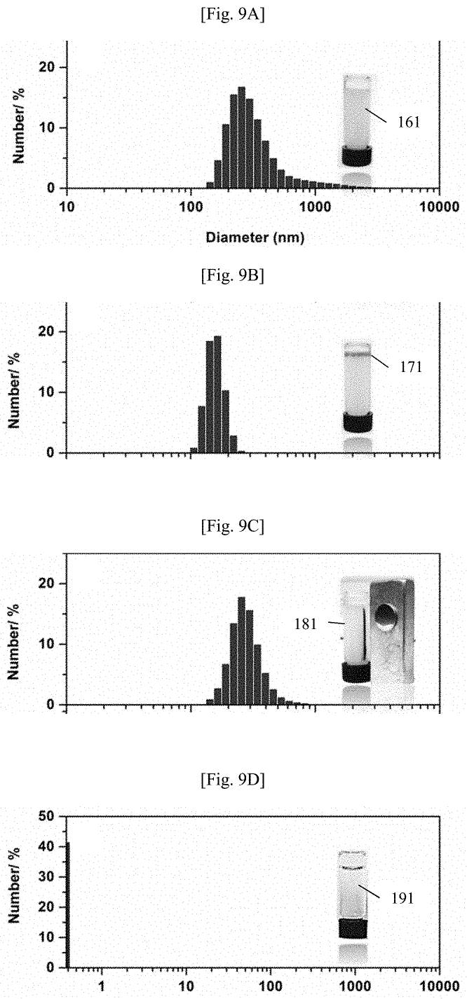

FIG. 8 shows the UV-Vis spectra of oil-in-water nanoemulsions (line A) and after treatment with P4VP-PDMS-P4VP copolymers (line B), Fe₃O₄@SiO₂ (line C) and Fe₃O₄@SiO₂@P4VP-PDMS-P4VP nanoparticles (line D), respectively. It can be observed that a transparent liquid was obtained after the system was treated with Fe₃O₄@SiO₂@P4VP-PDMS-P4VP nanoparticles, implying that there was no trace of oil in the water. The high separation efficiency was also confirmed by DLS measurements. Based on FIG. 9, it can be seen that there were no significant changes in the diameter of oil-in-water nanoemulsion (FIG. 9A) in orange-pink solution (161) after treatment with P4VP-PDMS-P4VP copolymers (FIG. 9B) and Fe₃O₄@SiO₂ (FIG. 9C) of a light pink solution (181), indicating that the oil droplets are still remaining in the water. The slight reduction in the diameter of oil-in-water nanoemulsion after treatment with P4VP-PDMS-P4VP copolymers is due to the partial oil droplets that are being captured by the copolymers floating on the surface (171). In contrast, the oil droplets disappear in the clean water (191) after separation by the Fe₃O₄@SiO₂@P4VP-PDMS-P4VP hybrid nanoparticles (FIG. 9D).

### Example 5

Absorption Capacity of Fe₃O₄@SiO₂@P4VP-PDMS-P4VP Hybrid Nanoparticles (NPs)

The absorption capacity is defined as the weight of oil that can be absorbed by the Fe₃O₄@SiO₂@P4VP-PDMS-P4VP nanoparticles per unit weight of nanoparticles. Based on the investigation, the maximum amount of oil that the functionalized sponge could absorb was measured to be 78.2 times the hybrid nanoparticles' weight (oil absorption ratio: 7820%). The high absorption capacity of the Fe₃O₄@SiO₂@P4VP-PDMS-P4VP nanoparticles could be due to the higher density of the block copolymer P4VP-PDMS-P4VP that is on the surface of Fe₃O₄@SiO₂ core.

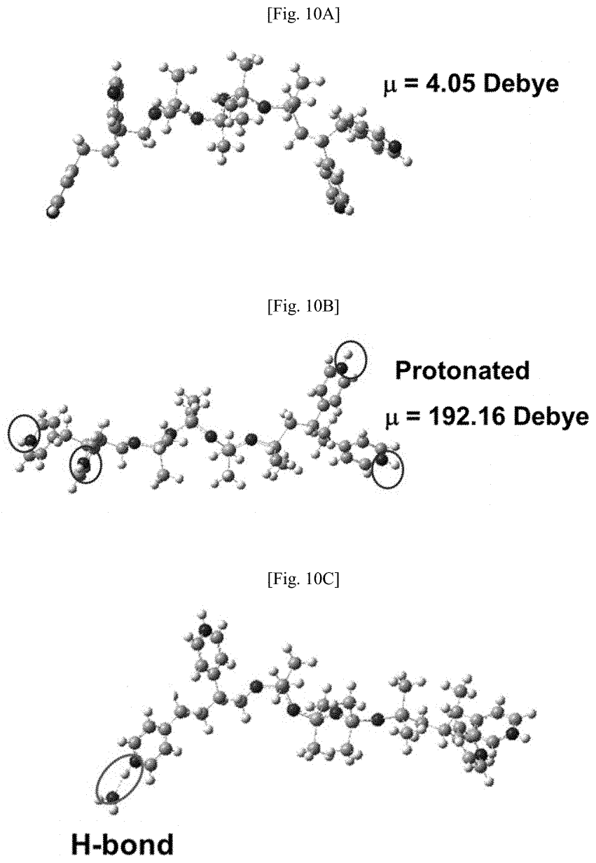

FIG. 10 shows the optimized structure of P4VP-PDMS-P4VP at pH 7 and pH 3 respectively, and the dipole value for each geometry. In neutral conditions, P4VP-PDMS-P4VP has a very small dipole of 4.05 Debye (FIG. 10A) that is expected to be a non-polar molecule and demonstrated a good miscibility in octadecene which is also non-polar. This is in line with the experimental phenomenon that hybrid Fe₃O₄@SiO₂@P4VP-PDMS-P4VP nanoparticles had a high affinity with oil at pH 7 as shown in FIG. 7. While in acidic conditions, the P4VP-PDMS-P4VP triblock copolymer was protonated and the DFT calculations predicted that the dipole would show a value of 192.16 Debye (FIG. 10B). In this regard, such a high dipole value would suggest that the protonated P4VP-PDMS-P4VP is polar and would result in good miscibility in polar solvents such as water (H₂O). These calculations correspond with the experimental findings on the release of absorbed oils from Fe₃O₄@SiO₂@P4VP-PDMS-P4VP nanoparticles at pH 3.

In summary, the different dipole values of P4VP-PDMS-P4VP and protonated P4VP-PDMS-P4VP are responsible for the different miscibility of the nanoparticles, where the polymer is non-polar and polar in neutral and acidic solvent environments respectively. Furthermore, there would be strong hydrogen bond between water molecules and pyridyl groups in protonated P4VP-PDMS-P4VP (H₂O—H—N). The calculated bond length and bond energy is 1.68 Å and 1.00 eV respectively. The existence of this hydrogen bond facilitates the miscibility of protonated P4VP-PDMS-P4VP in H₂O.

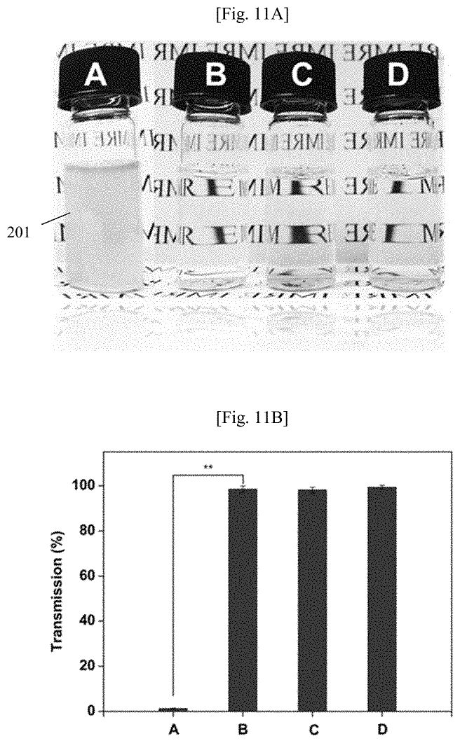

Moreover, the absorbed oil could be easily released from the hybrid nanoparticles by placing the oil-loaded hybrid nanoparticles into acidic water at pH 3. After washing with water at neutral pH and drying with nitrogen flow, the used hybrid nanoparticles that are being regenerated would have uperoleophilicity in neutral aqueous solution, making it reusable for selective removal of oil from water. As shown in FIG. 11A of the pink solution (201), no obvious changes can be found in the absorption capacity of the regenerated hybrid nanoparticles after three cycles of usage, indicating the excellent stability and reusability of the nanoparticles.

### INDUSTRIAL APPLICABILITY

The core-shell nanoparticle as defined above may be used to absorb oil from an oil-in-water nanoemulsion. Hence, the core-shell nanoparticle may be used in wastewater treatment or in treatment of oil spill or in industries where oil generated during a processing stage is required to be separated from the aqueous medium that it is generated in.

It will be apparent that various other modifications and adaptations of the invention will be apparent to the person skilled in the art after reading the foregoing disclosure without departing from the spirit and scope of the invention and it is intended that all such modifications and adaptations come within the scope of the appended claims.

1. A core-shell nanoparticle comprising:
a) an inorganic core comprising a nanoparticle comprising a metal, a metal oxide or combination thereof, and a silica component;
b) a shell material comprising a copolymer having at least two polymers selected from a pH-responsive polymer and a hydrophobic polymer; and
c) a crosslinker that conjugates the shell material to the inorganic core.

2. The core-shell nanoparticle of claim 1, wherein said metal or said metal oxide comprises a magnetic material, a ferromagnetic material or a superparamagnetic material.

3. The core-shell nanoparticle of claim 1, wherein said metal or said metal oxide comprises a metal selected from the group consisting of iron, cobalt, nickel, chromium, alloys of cerium, dysprosium, erbium, europium, gadolinium, holmium, lanthanum, lutetium, neodymium, praseodymium, promethium, samarium, scandium, terbium, thulium, ytterbium, yttrium, and mixtures thereof.

4. The core-shell nanoparticle of claim 1, wherein said metal oxide is selected from the group consisting of iron (III) oxide, iron (II) oxide, cobalt (III) oxide, cobalt (II) oxide, nickel (III) oxide, nickel (II) oxide, copper (II) oxide or copper (I) oxide, chromium (III) oxide, chromium (II) oxide, and mixtures thereof.

5. The core-shell nanoparticle of claim 1, wherein said silica component comprises a hydrocarbon group, an alkyl aryl group, an alkoxy silane group, or combinations thereof.

6. The core-shell nanoparticle of claim 1, wherein said copolymer is a block copolymer or a grafted copolymer.

7. The core-shell nanoparticle of claim 6, wherein said block copolymer comprises at least two blocks of polymers.

8. The core-shell nanoparticle of claim 1, wherein said pH-responsive polymer is selected from the group consisting of poly(4-vinylpyridine) (P4VP), poly(2-vinylpyridine) (P2VP), poly(methacrylic acid) (PMAA), poly(acrylic acid) (PAA), and poly(dimethylaminoethyl methacrylate) (PDMAEMA).

9. The core-shell nanoparticle of claim 1, wherein said hydrophobic polymer is selected from the group consisting of poly(dimethylsiloxane) (PDMS), poly(methyl methacrylate) (PMMA), polytetrafluoroethylene (PTFE), thermoplastic polyurethane (TPU), and polyvinylidene fluoride (PVDF).

10. The core-shell nanoparticle of claim 1, wherein said crosslinker is a bifunctional crosslinker.

11. The core-shell nanoparticle of claim 1, wherein said crosslinker comprises an alkyl group, an alkoxy group, a halogen group, a haloalkyl group, a silane group, or combinations thereof.

12. The core-shell nanoparticle of claim 1, wherein said core and said shell material are in a weight ratio of 10:90 to 90:10.

13. A method of preparing a core-shell nanoparticle comprising the step of:
conjugating an inorganic core comprising a metal, a metal oxide or combination thereof, and a silica component, with a shell material comprising a copolymer having at least two polymers selected from a pH-responsive polymer and a hydrophobic polymer.

14. The method of claim 13, further comprising the step of:
coating the surface of a nanoparticle comprising a metal, a metal oxide, or a combination thereof with a silica layer to form said inorganic core.

15. The method of claim 14, further comprising the step of:
immersing said inorganic core in a solution of a crosslinker to form a crosslinked inorganic core.

16. The method of claim 15, further comprising the step of:
immersing said crosslinked inorganic core in a solution of said copolymer to form said core-shell nanoparticle.

17. Use of a core-shell nanoparticle to remove oil and surfactant in an oil-in-water nanoemulsion, wherein said core-shell nanoparticle comprises:
a) an inorganic core comprising a nanoparticle comprising a metal, a metal oxide, or combination thereof, and a silica component;
b) a shell material comprising a copolymer having at least two polymers selected from a pH-responsive polymer and a hydrophobic polymer; and
c) a crosslinker that conjugates the shell material to the inorganic core.

18. A method of removing oil and surfactant in an oil-in-water nanoemulsion comprising the steps of:
a) mixing a core-shell nanoparticle in the oil-in-water nanoemulsion;
b) adjusting the pH of the nanoemulsion to thereby trap the oil in the nanoemulsion on a surface of the core-shell nanoparticle; and
c) applying an external magnetic field to separate the core-shell nanoparticle with entrapped oil from the water in the nanoemulsion,
wherein said core-shell nanoparticles comprise
i) an inorganic core comprising a nanoparticle comprising a metal, a metal oxide, or combination thereof, and a silica component;
ii) a shell material comprising a copolymer having at least two polymers selected from a pH-responsive polymer and a hydrophobic polymer; and
iii) a crosslinker that conjugates the shell material to the inorganic core.

19. A method of separating oil from an oil-absorbed core-shell nanoparticle comprising the steps of:
a) immersing the oil-absorbed core-shell nanoparticle into a solution of acid; and
b) washing the oil off a surface of the oil-absorbed core-shell nanoparticle with an aqueous solution at neutral pH,
wherein said core-shell nanoparticles comprise
i) an inorganic core comprising a nanoparticle comprising a metal, a metal oxide, or combination thereof, and a silica component;
ii) a shell material comprising a copolymer having at least two polymers selected from a pH-responsive polymer and a hydrophobic polymer; and
iii) a crosslinker that conjugates the shell material to the inorganic core.

20. The method of claim 19, further comprising the step of recycling said core-shell nanoparticle after said washing step (b).
